(19) United States
(12) Patent Application Publication
(10) Pub. No.: US 2018/0332355 A1
(43) Pub. Date: Nov. 15, 2018

(54) Method and System For Creation, Playback and Delivery of Interactive Multimedia and Advertising For IPTV Content Streams

(71) Applicant: Gregorio Ormasa Loveria, III, Conklin, NY (US)

(72) Inventor: Gregorio Ormasa Loveria, III, Conklin, NY (US)

(21) Appl. No.: 15/595,202

(22) Filed: May 15, 2017

(51) Int. Cl. H04N 21/472; H04N 21/422; H04N 21/443

(52) U.S. Cl. CPC H04N 21/47217; G06F 3/0481; H04N 21/4438; H04N 21/42204

(57) ABSTRACT

A method and system for the unique distribution of interactive multimedia and advertising for use with standard or typical Internet Protocol Television (IPTV) non-interactive content audio-video streams presently in use, and for combining, delivering and viewing the playback of such standard or linear IPTV content streams, with additional mixed media within an interactive playback device, which is an integral part of the of the inventive system's unique methods and means, so as to enable standard, non-interactive linear IPTV content streams to be easily enhanced so as to impart more information and knowledge to end users which thereby provide a greater benefit to end views. Such methods and systems of the instant invention simultaneously overcome the lack of any current IPTV content streaming technologies (or also know as Over the Top Television, often represented by the acronym OTT) to provide such interactive delivery and viewing of interactive IPTV content streams with new, unique and heretofore unknown revenue centers to generate additional profits for content stream owners. or for those firms or individuals in the business or enterprise of delivering and making available standard or linear IPTV content streams to end viewers. The instant invention's methods and systems further enable and make possible the distribution of interactive multimedia and advertising for standard linear IPTV/OTT content streams, in which the invention generally includes a ‘pop up’ interactive Graphical User Interface (GUI) that is “hidden’ behind standard linear and non-interactive IPTV/OTT content streams until the said GUI of the instant invention is invoked and displayed to the end user or content consumer. Because the interactive GUI is transparent and hidden to the end viewer until invoked, this method of the inventive process, and the methods and systems disclosed does not interrupt the end viewing experience of the streaming audio-video content until requested and invoked by the end viewer.

### COPYRIGHT NOTICE

A portion of the disclosure of this patent document contains material which is subject to copyright protection. The owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The present invention generally relates to streaming Internet Protocol Television (IPTV) content but can be applied to other content broadcast and delivery systems. The new methods and systems of the unique invention disclosed allow incorporating multimedia and advertising not currently possible in IPTV technology, and of which the later advertising methods and system of the invention allow for the creating of unique and heretofore unavailable revenue centers not available on any devices currently capable of delivering standard, non-interactive IPTV content streams to end viewers.

More specifically the invention disclosed relates to a method and system for the distribution of interactive multimedia and advertising for IPTV content streams, wherein the invention enables the unique combining of, and the delivery of and the viewing or playback of standard (IPTV) content streams, with additional mixed media, such as informational text and still images combined with or added to a standard IPTV content stream, so as to be displayed and viewed within an interactive playback GUI on TVs, HDTVs, or any device with a CPU and equipped with audio-video playback and display capabilities. Further, the methods and systems of the disclosed invention uniquely enable standard, non-interactive IPTV content streams to be easily enhanced for the purposes of imparting more information than that of simple, non-interactive audio and/or audio-video IPTV content streams presently known and in use, so as to provide a dramatically improved end user informational experience and educational benefit, amongst other benefits.

Further, the instant invention disclosed also overcomes the lack of any current IPTV content streaming technologies, such as found with IPTV firms or individuals engaged in the processes or methods of IPTV streaming content delivery, and overcomes the lack of any IPTV delivery devices to provide the delivery, viewing and/or playback of interactive IPTV content streams while simultaneously enabling the creation of new, unique and heretofore unknown revenue centers for content stream owners or for those in the profession or business of currently delivering non-interactive IPTV content streams, which presently such methods and systems are not capable of.

### SUMMARY OF THE INVENTION

The invention generally relates to the transmission and delivery to end viewers, subscribers or recipients of standard, non-interactive linear streaming of IPTV content, unique and heretofore undiscovered improvements to such non-interactive IPTV content streams, that by means of the inventive system disclosed can now be enhanced and improved with the integration of additional multimedia and advertising elements, of which the unique invention includes a ‘pop up’, interactive Graphical User Interface (GUI) that is “hidden” behind a standard or linear and non-interactive IPTV content stream, of which said the GUI is incorporated within an Interactive Playback Viewer (IPV) system and methodology of the invention and does not appear until invoked by the end viewer. Because the interactive IPV's GUI is transparent and remains hidden to the end viewer until invoked by the end viewer or recipient, whereas more particularly, such methods of the instant invention does not interrupt or detract in any way to the linear content stream being viewed until the instant invention presented is invoked by the end user or when needed or desired, by commands within the associated synchronization component data or files of the invention, as detailed further below. Thus, such unique methods of the inventive process and system disclosed does not interrupt the end viewing experience of the standard and linear streaming of the audio, and/or audio-video content IPTV stream being viewed in a non-interactive manner until requested or invoked by the end viewer.

Therefore, the above broadly outlines some of the unique features of the invention in order that the detailed description of the invention may be better understood, and also so that the present uniqueness of the invention may be better appreciated which allows the art of the invention to be easily taught to those and others skilled in the art. There are additional features of such methods and systems which comprise the unique invention disclosed that will be described and detailed hereinafter so as to further aid in the understanding of the invention and the teaching of its art.

In this respect, before providing at least one present embodiment of the invention in descriptive detail, it is to be understood that the invention is not limited in its application to the details of construction or to the arrangements of the components set forth in the following description or as illustrated in the drawings. The invention is capable of other embodiments and of being practiced and carried out in various ways on other IPTV delivery devices not disclosed herein. Also, it is to be understood that the phraseology and terminology employed, and any lexicography instituted by the inventor as their own lexicographer herein, as set forth in 35 U.S.C. § 112(b) or pre-AIA 35 U.S.C. § 112, is for the purposes of setting forth the description and teaching of the invention and should not be regarded as limiting in any manner whatsoever. With the above understandings, the terminology sometimes used within to speak about, discuss or describe non-interactive IPTV content streams, may be set forth herein as “standard IPTV content streams”, “typical IPTV content streams”, “linear IPTV content streams”, “IPTV content streams”, “non-interactive IPTV content streams” or a combination of any of these terms.

Another object of the the invention, and its methods and systems disclosed and taught herein, are for the distribution of interactive multimedia and advertising for standard and linearly delivered IPTV content streams, so as to easily enable and make possible for others to create and derive the benefits of combining, delivering and viewing the playback of standard or linear non-interactive IPTV content streams with additional mixed media within an interactive playback device. Another uniquely beneficial object of the invention, derived in part from the above described systems and methods of the invention, is that the invention enables standard or linear non-interactive IPTV content streams to be easily enhanced so as to impart more information and provide a greater end user benefit of imparting additional knowledge and making the retention of such knowledge easier and more enjoyable and interesting to the end user or end viewer. Once again, these unique methods simultaneously create another object or unique method of the invention in that it overcomes the lack of any current IPTV content streaming technologies or IPTV devices to provide the means, methods and systems of the invention disclosed to provide the benefits defined and presented herein as can be gained from such interactive delivery and viewing of interactive IPTV content streams, and via these new, unique and heretofore unknown methods, also creates new and unique revenue centers for content stream owners or for those individuals, firms, businesses or other enterprises engaged in or that may become engaged in the streaming of non-interactive linear, or standard, IPTV content streams.

Another object of the instant invention is to provide a method and system for the distribution, and/or broadcast, and/or what can be termed as an Internet multicast, of interactive multimedia and advertising for standard IPTV content streams that overcomes the lack of interactivity experienced when end viewers and/or consumers watch simple or standard linear IPTV streams of movies, television or other entertainment or educational content streams.

Another object is to provide a method and system for the distribution of interactive multimedia and advertising for and within standard IPTV content streams so that providers of such standard IPTV streaming content (e.g, Netflix, Hulu, Crackle, YouTube, etc.) can easily incorporate the inventive system disclosed so as to allow such standard content streams provided by said firms to create, transmit and display an interactive experience to their customers, subscribers or end viewers, thereby enhancing the end user viewing experience to the benefit of such firms. Such unique methods of the inventive system disclosed thereby enable benefits for all such parties.

Further, within the inventive system disclosed additional benefits are derived by such businesses, firms, enterprises or individuals engaged in, or that may become engaged in, the transmission of such standard IPTV content streams so as to enable the retaining of and maintaining of a streaming content provider's subscriber and viewership base. Additional benefits of the inventive system disclosed and taught herein, allows those that enable or employ the invention to simultaneously attract new subscribers, thereby increasing said provider's viewer and subscriber base, thereby in this particular instance set forth, also increases said content stream provider's revenues and profits.

With the above in mind, a further object of the invention is that by providing such methods and systems for the creation, distribution and playback of such interactive multimedia and advertising for standard IPTV content streams, is that the invention creates heretofore unrealized, new and unique revenue and profit centers for such streaming of standard IPTV content for the content owners or the content stream providers, by enabling advertising to be incorporated within the interactive multimedia end viewer experience, again which is made possible by the unique and new methods within the inventive system disclosed.

Another object of the unique invention disclosed is that by providing a method and system for the creation, distribution and playback of interactive multimedia and advertising for standard and linear IPTV content streams is that the invention enables both streaming content owners, distributors, firms or end users to have more control of the IPTV content stream being viewed or watched, so as to allow for the end user to be exposed, as desired by an of the above mentioned parties, to a more informative, educational and enriching multimedia experience with combining informative materials or elements so as to further entertain, educate, inform and expose said end viewers to other content relevant information, and even non-content relevant information, and when desired uniquely delivered interactive unobtrusive, yet unavoidable advertising to the benefit and profit of said streaming content owners, or those firms or individuals engaged in such.

Other objects and advantages of the present invention will become obvious to the reader and, it is intended by the inventor that these objects and advantages are to be described within the scope of the present invention so that it can be easily taught to those skilled in the art. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention disclosed and taught within will become fully appreciated as the same becomes better understood and when considered in conjunction with the accompanying drawings, in which like reference characters designate the same or similar parts throughout the illustrated views, and wherein:

FIG. 1: So that the art of the invention may be more thoroughly disclosed, understood and taught to the reader, FIG. 1 is an overview chart of standard or typical Internet Protocol Television (IPTV) streaming methods and systems. FIG. 1 contains, amongst other descriptive elements and methods, an approximate 25 degree, left side view of a standard movie (a feature film western now in the public domain) being broadcast as a non-interactive, linear IPTV content stream being served and streamed through the Internet, or other transmission means, to an end viewer from a remote content storage server, of which the said non-interactive linear IPTV stream is ultimately received and displayed on the screen of a 1920 pixel across×1080 line down resolution of a High Definition television (HDTV), although any other devices equipped with a CPU and audio output and visual display, may be displayed at higher resolutions, such as at 4K Ultra Hi Definition (aka 4K or 4KUHD) resolutions or higher, such as 3840 pixels×2160 lines, 5120 pixels×2160 lines, 4096 pixels×2160 lines, 4096 pixels×1716 lines, 3996 pixels×2160 lines, or at 8K UHD resolutions, which displays 7680 pixels 4320 lines or at even higher display resolutions as they become accepted and available, or at the older NTSC standards of displaying analog and digital video at 640 pixels×480 lines, as used on United States and Japan standard definition TVs, or in the PAL TV format and other resolutions of TVs used elsewhere in the world, or at lower than these standard or HD resolutions as are often displayed on any one of many devices equipped with a CPU and audio and video outputs.

FIG. 2: FIG. 2 is a front view of one particular embodiment of the invention's Interactive Playback Viewer's (IPV) Graphical User Interface (GUI) placed in Media Mode. The IPV's GUI appears as it functions in Media Mode when it has been invoked by an end user's actions and made visible, from waiting to be invoked from behind a standard IPTV stream, so as to replace the non-interactive IPTV full screen content stream shown in FIG. 1, and whereas the IPV's GUI and other elements of the invention contained therein are being displayed on the screen of a 1920×1080 resolution High Definition television (HDTV).

FIG. 3: FIG. 3 is a front view of one particular embodiment of the invention's Interactive Playback Viewer's (IPV) Graphical User Interface (GUI) in Info Mode (or in software terminology focused in Info Mode), so as to detail and teach how an end user utilizes the navigable interactive methods within the IPV's GUI of the invention. In Info Mode, and using the IPV's GUI, end viewers can display and easily navigate through sequences of informational textual screens that may or may not be relevant to the audio or audio/video IPTV content stream. The illustration further details how such navigation through the sequence of the textual screens is accomplished using a well known IPTV delivery device's remote control command key sequences. The figure also displays the IPV's GUI and other elements of the invention in Info Mode contained therein, again as being displayed on the screen of a 1920×1080 resolution High Definition television (HDTV).

FIG. 4: FIG. 4 is another front view of one particular embodiment of the invention's Interactive Playback Viewer's (IPV) Graphical User Interface (GUI) placed and focused in Image Mode, so as to detail and teach how an end user utilizes the navigable interactive methods within the IPV's GUI in this mode of the invention. In Image Mode using the IPV's GUI, end viewers can display and navigate through sequences of informational image screens that can or may be relevant to the audio or audio/video IPTV content stream. The illustration further details how such navigation through the sequences of the image and advertisement screens are accomplished using an IPTV device's remote control. The figure also displays the IPV's GUI and other elements of the invention in Image Mode contained therein, again as being displayed on the screen of a 1920×1080 resolution High Definition television (HDTV).

### DETAILED DESCRIPTION OF THE INVENTION

### A. Overview

Turning now descriptively to the drawings, in which similar reference characters denote similar elements throughout the illustrative views, the following is an overview of the invention and its unique methods and system shown in its current embodiment disclosed, and in some instances, other anticipated embodiments.

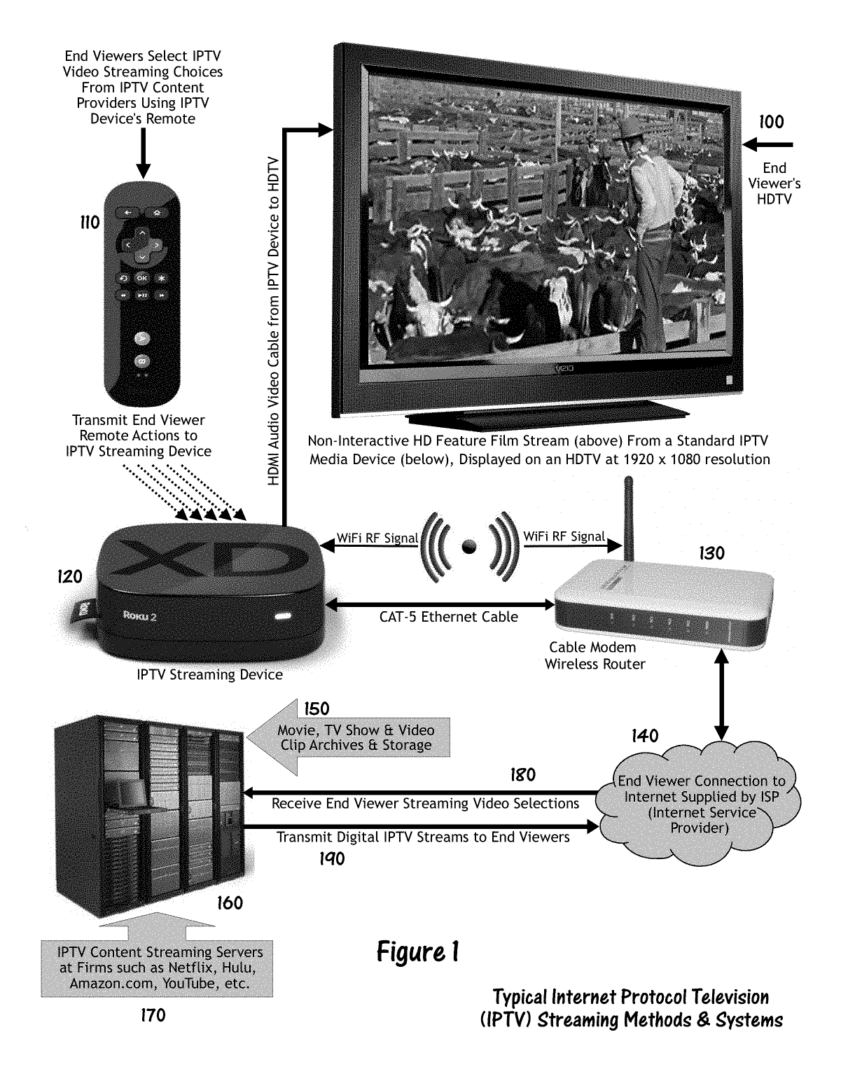

As detailed in FIG. 1, currently, streaming media companies 170 offering typical or standard IPTV delivery of various audio and audio-video IPTV streams 190, and simply serve up non-interactive movies and TV shows, and other non-interactive or linearly streaming digital audio-video, and/or digital audio content 150 to their viewers, customers and subscribers 100. Said streaming of linear or standard non-interactive IPTV digital content streams 190 are made available and delivered to end viewers on their televisions 100 in a variety of means and methods as in the known means and methods such as set forth in the following:
(1) free of charge linear and non-interactive IPTV content streams 190, (i.e., available as public domain content and movies from standard IPTV remote content servers 160, for example such as found on web sites operated by “The Internet Archive”, “YouTube”, “Vimeo” and other such enterprises 170), or;
(2) free of charge linear and standard IPTV content streams 190 that are combined with commercials or advertisements of 15-to-30 seconds or more in length, of which said audio-video commercials are interjected into and as part of the linear or standard IPTV content stream, or where they may be interjected and spaced in planned intervals, within the standard IPTV content stream 190, i.e., whereas the non-interactive, linear IPTV stream is available to end viewers 100 for free as no charge linear IPTV content streams 190 consisting of movies or TV shows, or other such video clip content 150, as can be found on remote linear IPTV content servers 160 and as operated by firms 170 such as YouTube, Google Video, or Crackle, of which the later is owned and operated by Sony Entertainment, or whereas such audio/video advertising that are simply standard TV linear video TV commercials injected into a linear video program's broadcast stream which can be readily experienced when viewing such on regular, non-IPTV television broadcasts, or;
(3) on a subscription basis to paying subscribers 100, and as can be experienced and viewed on web sites, or via standard IPTV delivery devices, as served up by firms 170 such as Netflix, or Hulu, of which the Hulu revenue model consists of the injection of standard TV commercial advertisements within the Hulu IPTV linear non-interactive content stream 190, or;
(4) on a rental basis as pay-per-view IPTV non-interactive, linear content streams 190, (such as found on and experienced when delivered from streaming content firms 170 or on-demand cable companies such as the Spectrum cable TV, VOIP and ISP firm, or Amazon's streaming video offerings and other such firms engaging in such content streaming), of which such digital delivery business models and methods simply emulate the long established standard video store rental models of commerce, wherein the end viewer pays for the rights to rent for a limited amount of viewing time, or where they may also purchase the rights to own digital or audio copies of a film, movie, TV show or other audio-video content which can be stored on a physical DVD or in an analog format VHS tape, or digitally in cloud servers and within or on other such digital media storage devices.

The linear and standard streaming methods of non-interactive IPTV content 190 begins when an IPTV content stream provider 170 digitizes and stores digital copies of movies, TV shows and video clips 150 stored as digitized audio-video or digitized audio files on their enterprises' content streaming servers 160 or on CDNs (Content Data Network servers, also known as cloud storage servers.) An end viewer wishing to view such typical non-interactive IPTV content streams 190, must acquire an IPTV streaming device 120 (or a TV 100 equipped to receive such) and connect the streaming device 120 it to their television 100. This is usually accomplished by the end viewer via an HDMI, A/V or S-Video cable or a combination of such connection cables. The IPTV streaming device 120 is then also connected to the Internet 140 through a wired or wireless Internet Service Provider (aka ISPs or WISPs) 140, via a WiFi or Ethernet connection using a cable modem 130, or wireless receiver, of which on some cable modems or wireless Internet receivers can also include a wireless router that both transmits and receives digital Internet data via any number of commonly used and defined radio frequency (RF) standards. Once connected to the Internet, 130 and 140, an end viewer with an IPTV streaming device 120 connected to their TV 100 is presented with menus developed by the non-interactive IPTV firm 170 or individuals engaged in said enterprises, to allow selecting the digitized audio and/or audio-video clips, films and TV shows 150 consisting of digital files so as to be transmitted back through the Internet as digital packets that comprise a typical IPTV content stream, whereas ultimately the standard IPTV stream is displayed and viewed on their (the end viewer's) TV 100. As previously noted, such IPTV streaming capabilities 120 can also be directly built in to HDTVs 100 where upon the instant invention can also be implemented and viewed by end users without modification to their IPTV viewing devices 120 and TV 100 equipment.

To explain the process in further detail, using the standard IPTV streaming device's 120 remote control 110 as shown, the end user transmits their choice of audio or audio-video selection 180 through the IPTV streaming device 120 connected to the Internet 140, which is received at the IPTV content storage and streaming server 160, or CDN, where in turn such streaming content servers acknowledge such end user IPTV content selection requests and then sends or returns packets of audio-video or audio data streams 190 which are received by the standard IPTV streaming device 120, which in turn decodes and displays such standard IPTV content streams as a linear movie, TV show or video clip to be viewed linearly, most often with at least some means of pausing, rewinding or fast forwarding the IPTV linear content stream, on the end viewer's television 100.

Though IPTV delivery of such linear and standard non-interactive content streams 190 enables end viewers to watch what they want, and when, on their TV 100 through an IPTV enabled device 120, or TVs 100 equipped with internal IPTV streaming. End users often connect well known IPTV steaming devices 120 to the TV 100 like the Roku IPTV box or Roku stick, the AppleTV box, or the Amazon Fire HD box or Amazon Fire Stick HD, or other many other IPTV streaming devices 120, etc.), where listening to audio or watching the film, TV show or video clip stream delivered to the end user is accomplished via a standard, linear and non-interactive IPTV content stream 190, whereas such methods presently have no interactive viewing enhancements of a movie or TV show or video clip program 150. Such non-interactive viewing of typical IPTV content streams can be also be identically experienced when an end viewer is simply playing the film, TV show or video clip 150 directly from a non-interactive DVD or VHS video tape, or in the same delivery manner and viewing methods experienced when listening to or viewing other linear radio and television program broadcasts via the well known methods of standard digital and analog TV broadcasting and transmission methods as noted previously above.

Further when standard or linear, non-interactive streaming IPTV content 190 is simply displayed within a non-interactive streaming or TV viewing environment 100, for those companies or individuals engaged in the business of streaming IPTV media and content to IPTV enabled devices 120, or again TVs 100 enabled internally to receive and display IPTV content streams 190, there does not exist a method or means to create and implement profit centers or business revenue models such as those disclosed within the instant inventive system on any of these IPTV devices 120 within, or on TVs 100 internally enabled to receive and display IPTV content streams 190, or other devices equipped with a CPU and audio-video output methods, such as cellular phones or tablets, or in conjunction with the standard IPTV data stream along with the non-interactive IPTV stream 190.

The inventive system and its methods overcome the above limitations of viewing linear, non-interactive IPTV streams 190 in a standard manner on the end viewer's TV 100, while simultaneously, the inventive system disclosed enables firms 170 or individuals engaged in the business of streaming non-interactive IPTV content 190 to easily add unique revenue models and profit centers to their current business models of streaming non-interactive IPTV content 190.

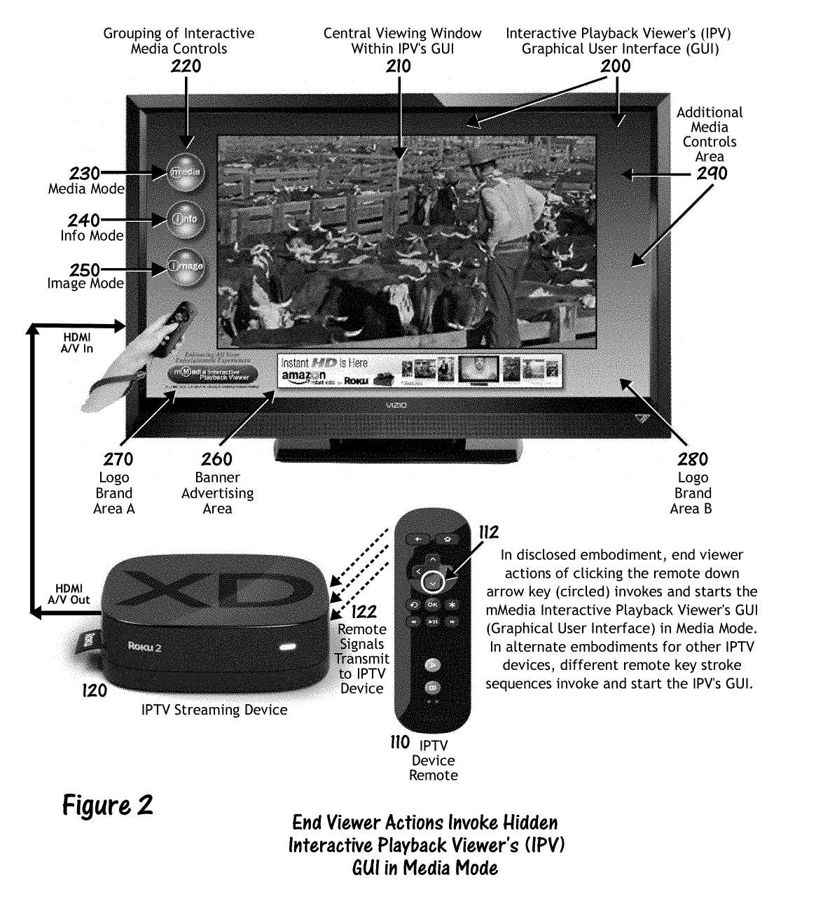

Turning to FIG. 2, a ‘pop up’ interactive Graphical User Interface (GUI) 200 implemented within the invention's Interactive Playback Viewer (IPV) 210 methods are disclosed, whereas the inventive system's GUI 200 is “hidden” or concealed behind a standard, linear non-interactive IPTV content stream (FIGS. 1, 190 & 100). In the herein disclosed embodiment of the invention, the IPV's GUI 200 of the inventive system consists of a background digital image file, which can be stored on a remote computer server's 160 hard drive(s) or in an IPTV device's 120 RAM, and said GUI's 200 background image file(s) may be stored in any known or future image format, presently in such standards such as as .JPG, PNG, TIFF, BMP, etc.

The IPV's GUI 200 of the inventive system therefore remains non-visible and underneath the non-interactive and linear IPTV content stream 190 that is being displayed full screen until the IPV's GUI 200 is invoked by the end viewer 100.

Because the interactive GUI 200 of the inventive system is transparent or hidden (not displayed) to the end viewer 100 until invoked by certain key sequences on the IPTV device's 120 remote control 110, this method of the inventive system is beneficial and unique as it does not in any manner interrupt the end viewing experience of the typical or standard IPTV streaming content being viewed linearly 190 until requested and invoked by the end viewer 100. It is well known that such end viewer 100 experiences are extremely important to the revenues and profits of those firms, businesses, enterprises or individuals engaged in delivering typical broadcast television, on demand content or standard IPTV content streams, as such firms consistently and regularly send out email, phone and other such surveys requesting end viewer commentary and opinions on the quality and experience of the typical IPTV content streams or TV broadcasts that end user consumers have viewed.

### Interactive Central Viewing Window

As detailed in FIG. 2, the IPV's interactive GUI 200 includes a main and central viewing window 210 where interactive elements of different medias are displayed within the central viewing window 210 fixed within the IPV's GUI 200. The software code comprising the unique methods and systems which make up and comprise the inventive system disclosed, is either stored on a remote computer server's 160 hard drive(s), often presently referred to as ‘the cloud’ or alternately, it can be stored as software coded within RAM, EPROMs or ASICs within the electronic components comprising said set top TV devices 120 or the RAM of such IPTV internally equipped TVs 100, or any device with a CPU and audio-video output capabilities such as computers, cellular phones, tablets or other such devices, or called from remote server access 160, by such IPTV delivery devices 120 or within the RAM, EPROMs or ASICs of such IPTV delivery devices 120.

The main and central viewing window 210 of the IPV's GUI 200 of the invention (also known as the “Interactive Central Viewing Window” or ICVW), 210 is programmed and configured to be re-sizable and viewed at various TV resolution standards but may remain centrally fixed within the IPV's GUI 200 when required or desired. Though often more centrally fixed within the IPV's GUI 200, the Central Viewing Window 210, is fixed via the programming and coding for this embodiment of the invention disclosed, and whereas further the IPV's GUI 200 can be auto-re-sized to display properly at the resolution of any number of TV 100 standards, such as the NTSC Standard Definition (SD) resolution of 640 pixels×480 lines down, or; a variant of the NTSC High Definition standard of 720p/i (1280 pixels×720 lines) or; the highest variant resolution of the NTSC High Definition standard of 1080p/i (1920 pixels s×1080 lines) or any of the standard PAL or Secam television display formats. Any NTSC, PAL, Secam format at any of the standard definition TVs or HDTVs, 4kUHD TVs, or 8K UHD TVs 100 or even higher resolutions or any device equipped with a CPU and audio-video output capabilities may implement the methods and systems of the instant invention as herein taught by those skilled in the art.

### Interactive Media Controls

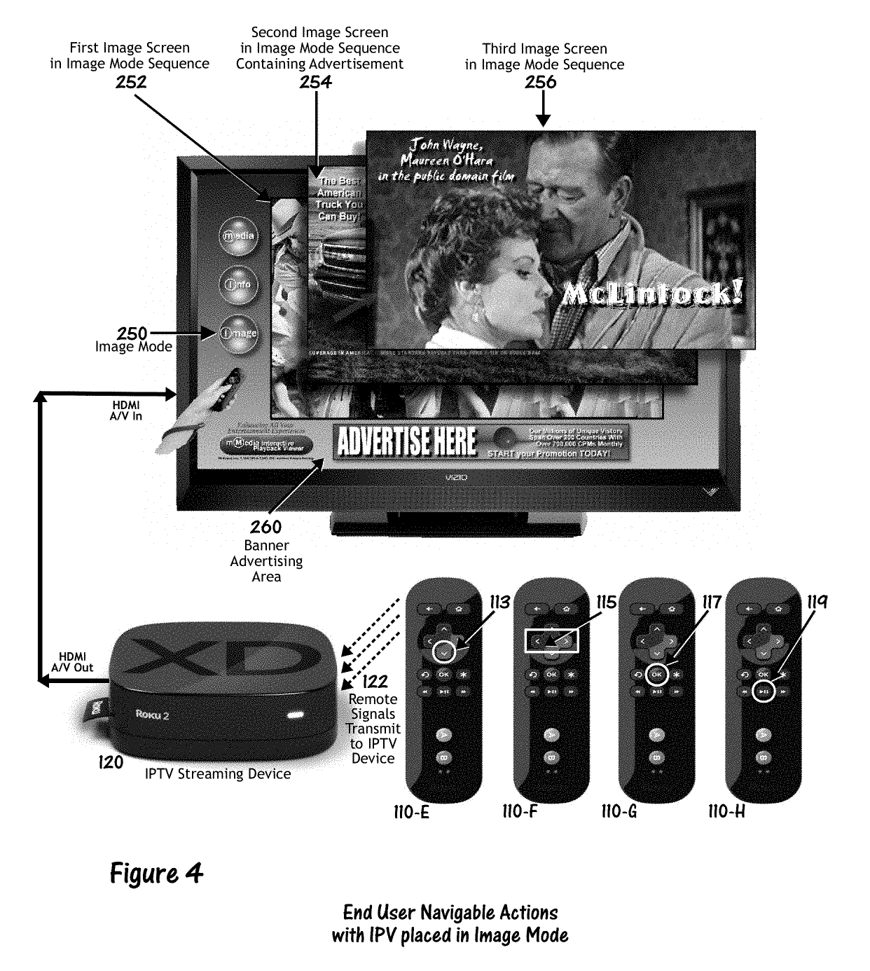

The IPV 210 of the instant invention's GUI 200 includes a group of interactive controls 220 to enable end viewer's to advance and navigate among the various media modes of the IPV's GUI 200, which includes a Media Mode 230 for listening to audio, or viewing audio-video media; an Info Mode 240 for displaying informational text screens which may be relevant to the audio or audio video contained within or transmitted as an adjunct to the typical and standard IPTV content stream; an Image Mode 250 for displaying informational image screens which may or may not be relevant to the typical or standard non-interactive IPTV content stream, and of which both media content elements displayed within either the Info Mode 240 and Image Mode 250 of the inventive system disclosed, can contain advertising elements and/or screens (FIG. 4, Item 254), and whereas other extra and unlimited amounts advertisements can be included within the IPV's GUI 200 itself via its linked banner advertising area 260, discussed in more detail below.

The Interactive Media Controls 220 of the inventive system disclosed, consist of inactive non-highlighted, and active highlighted circular buttons 230, 240 and 250 that may be ‘clicked upon’ (or ‘pressed on’ for such those devices with touch sensitive displays) by the end user to place the IPV's GUI 200 into the various media viewing modes of the IPV's GUI 200 as described previously (e.g., Media Mode 230, Info Mode 240, Image Mode 250 and Banner Mode Advertisement Display 260), again as noted, all of which may be interacted upon by touching or clicking on by end viewers so as to navigate within the inventive system's interactive media display methods and systems disclosed.

Alternately the Interactive Media Controls 220, in other embodiments of the invention, may consist of inactive non-highlighted and active highlighted circular, square or alternately shaped buttons or user selection devices that can be the shape of any form, all of which may be clicked or touched upon by the end user to place the IPV 200 into the various interactive media viewing modes of the inventive system (i.e., Media Mode 230, Info Mode 240, Image Mode 250 and Banner Mode 260.) In other embodiments of the invention, however, an end viewer significantly familiar with the operation of the invention system may elect not to utilize the IPV's GUI 200 whatsoever, and in such advanced viewer modes, not shown, end viewers may navigate any of the interactive modes of the inventive system disclosed herein, or as disclosed above, to view the textual 240 and image 250 elements of the inventive system using just the IPTV device's 120 remote 110 without invoking or displaying the IPV's GUI 200. These later non-IPV/GUI 200 display methods and means of the instant invention's systems may be invoked by end users on any device equipped with a CPU and audio-video outputs, such as on cellular phones and tablets or other such devices with touch screens, and the Media Mode 230, Info Mode 240, Image Mode 250 or Banner Mode 260 of the invention may be implemented by swiping a finger upon or on some devices by waving a hand over a touch sensitive screen or motion sensor, which can optionally be implemented without displaying the GUI 200 of the instant invention, and whereas end users can navigate fully through the Media Mode 230, Info Mode 240, Image Mode 250 and Banner Mode 260 of the instant invention.

Additionally, when elected to be invoked and displayed by the end viewer on their TVs 100, or other devices equipped with a CPU and audio-video outputs, the IPV's GUI 200, also contains areas for the expansion or addition of other media controls 290 which can be added where required or desired, and whereas there are also areas for brands or logos to be displayed, 270 and 280, of which the later areas can be important for any firm or individual implementing the inventive system disclosed herein by impressing their trademarks or brand on end viewers 270 or by adding additional sponsorship profits by adding a sponsors logo at the shown logo area 280 simply by changing or adding, either, remotely stored on and transmitted from a remote server 160 or such branding graphics or logos 280 can be stored within the RAM of any IPTV device 120 or any such device equipped with a CPU and audio-video output, to allow the IPV GUI's 210 background graphic image file or IPV 200, defined and disclosed above, from which the basic GUI 210 of the IPV 200 is generated. Such Full Screen Media Viewing means and methods are next disclosed and taught so as to be implemented by those skilled in the art.

### Full Screen Media Viewing

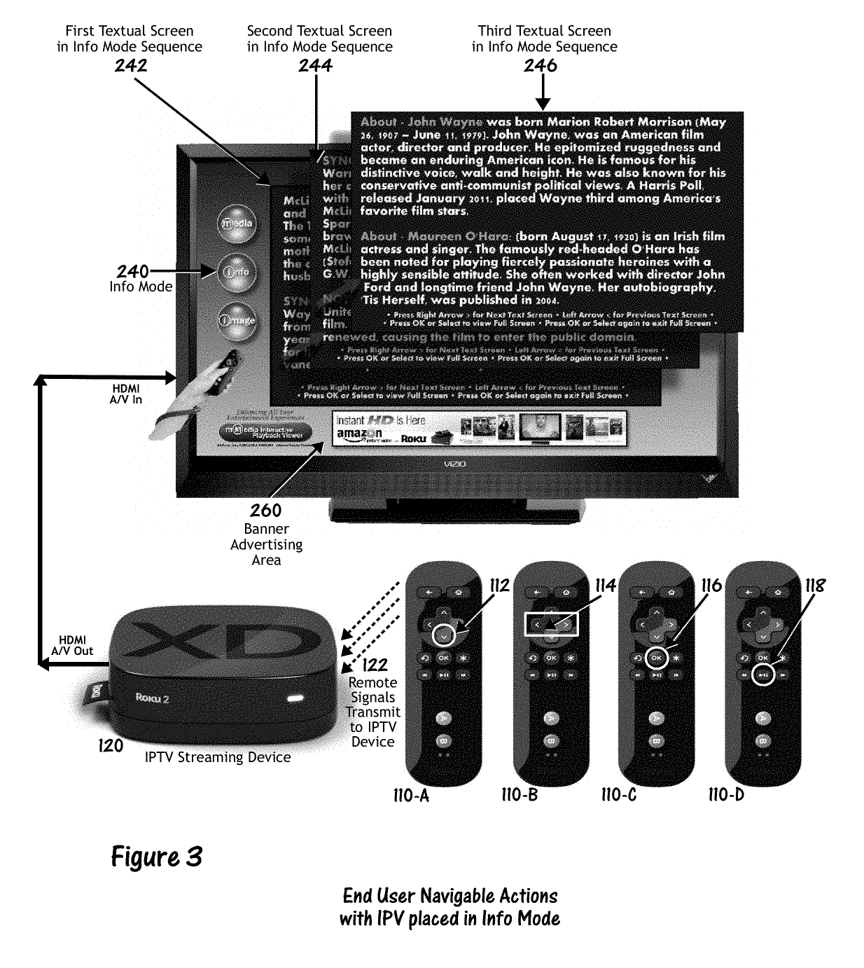

Turning to FIG. 3, the media elements of the inventive system disclosed, consisting of the sequence of informational text screens displayed when the IPV's GUI 200 is in Info Mode 240, can be be viewed either in full screen or in a smaller area within the GUI's central display window 210, whereas such a choice is made based upon the end viewer's input commands by pressing certain keys on the IPTV streaming device's 120 remote control 110, or by end users on any device equipped with a CPU and audio-video outputs such as on cellular phones and tablets or other such devices with touch screens, and where Media Mode 230, Info Mode 240, Image Mode 250 and Banner Mode 260 may be implemented by swiping over or touching a finger upon the device's touch screen or by waving or swiping various hand gestures over a device's motion sensor driven display or touch sensitive screen. Again, such methods work on any device equipped with a CPU and audio-video outputs, and/or whereas such motion or touch sensitive components of a device are available.

With the inventive system in Info Mode 240, an unlimited number of informational textual screen elements may be displayed either full screen or within the IPV GUI's 200 central viewing window 210. Such textual screen elements 242, 244 & 246, which may or may not contain information relevant to the typical or standard audio or audio-video IPTV content stream, are or can be pushed when desired or required to the IPV's GUI 200 from any IPTV streaming firm's or individual's remote server (FIG. 1, 160) that is streaming the typical or standard IPTV content stream.

For example, when the instant invention's IPV GUI 200 is placed into Info Mode 240, unobtrusive, yet unavoidable video files or still image graphical display advertisements can also be intermixed within the IPV GUI's 200 Info Mode's 240 informational text screens 242, 244 & 246 (note: said advertisements are not fully shown in the drawings.)

The Info Mode's 240 informational text screens 242, 244 & 246 are pushed to the IPV's GUI 200 from the IPTV streaming device 120 from a single remote server 160, or any number of remote servers 160, connected to the Internet 140, as image files 242, 244 & 246 that may contain said textual information 242, 244 & 246 as rasterized or graphical text elements within images 252, 254 & 256 in standard or known image file formats (e.g., as JPGs, BMPs, PNGs, GIFs, or in any other number of known or future digital image formats), or alternately, such informational textual screens 242, 244 & 246 may be served up or pushed to the IPV of the instant invention's GUI 200 as standard ASCII, XML, HTML or other such encoded textual screens 242, 244, 246. As also detailed in FIG. 2, an unlimited number of informational Info Mode 240 text screens 242, 244, & 246 can be pushed from any remote server 160 to the IPV's GUI 200 of the invention to be displayed in its central viewing window 210.

In the FIG. 3 embodiment of the invention disclosed, another down arrow click 112 of the IPTV device's 120 remote control 110-A by the end viewer, next puts the IPV′ GUI 200 into Info Mode 240. Again, enabling Info Mode 240 allows the end viewer to call up and view an unlimited number of remotely served, yet easily navigable, text screens 242, 244 & 246, interactively providing end viewers with informative textual information or data that may (or again may not) be relevant to the film, television show or video clips 150 contained within the non-interactive, typical IPTV content packet stream 190.

Said informational textual screens 242, 244 & 246, viewed from within the inventive system's Info Mode 240, can contain anything of consequence or interest to the end viewer, ranging from from historical and biographical information to production note data, to name just a few items or elements, of what may be contained within such screens 242, 244 & 246, so as to enhance the end viewer's informational, educational, entertainment and viewing experience and supplanting further knowledge that may or may not have been imparted in the IPTV audio-video content stream 190. Choices of navigation through the informational textual screens 242, 244 & 246 in Info Mode 240 are set forth in FIG. 3, wherein by pressing the IPTV device 120 remote's 110-A down arrow key once, moves the focus or control of the IPV's GUI 200 from Media Mode 230 to Info Mode 240. Informational textual screen elements 242, 244 & 246 can be viewed in a forward or reverse sequence by pressing the IPTV device 120 remote's 110-B right arrow or left arrow keys 114. Pressing the remote's 110-C “OK” or “Select” key 116 displays the informational text screen elements 242, 244 & 246 in full-screen mode, while pressing the remote's 110-C “OK” or “Select” key 116 returns the sequenced display of the informational text screen 242, 244 & 246 elements to once again be viewed at reduced sizes. fitting within and displaying the IPV GUI's 200 central display window 210. Pressing the remote's 110-D “Play” key 118 displays any number of the informational text screen 242, 244 & 246 elements in an automatic slide show sequence.

Turning to FIG. 4, the media elements consisting of the sequence of informational image screens 252, 254 & 256, displayed when the IPV's GUI 200 is in Image Mode 250, can be be viewed either in full screen or in a smaller area within the GUI's central display window 210, whereas such a choice is made based upon the end viewer's input commands by pressing certain keys on the IPTV streaming device's 120 remote control 110.

With the inventive system in Image Mode 250, an unlimited number of informational image screen elements may be displayed either full screen or within the IPV GUI's 200 central viewing window 210. Such informational image screen elements 252, 254 & 256, which may or may not contain information relevant to the standard or typical IPTV audio or audio-video content stream, are or can be pushed to the IPV's GUI 100 from any IPTV streaming firm's or individual's remote server or CDN (FIG. 1, element 160).

For example, when the instant invention's IPV GUI 200 is placed into Image Mode 250, an unlimited number of unobtrusive, yet unavoidable advertisements can also be intermixed within the IPV GUI's 200 Image Mode's 250 informational image screens 252, 254 & 256 (note: an example of a portion of a display advertisement within the image sequence is shown as noted within this drawing at element 254.) This method of the instant invention creates another a unique revenue or profit center that is not presently found in or used in conjunction with any presently known IPTV 190 audio-video content streams.

The Image Mode's 250 informational image screens 252, 254 & 256 are or can be pushed to the IPV's GUI 200 from the IPTV streaming device 120 from a single remote server 160, or any number of remote servers 160 or CDNs, connected to the Internet 140, as media element files 252, 254 & 256 as graphical raster or vector images in standard or known file formats (e.g., as JPGs, BMPs, PNGs, GIFs, WMV, FLU, SWF, or in any other number of known digital image or content storage formats.) As also detailed in FIG. 2, an unlimited number of informational Image Mode 250 image screens elements, such as illustrated at 252, 254, 256 can be pushed from any remote server 160 to the IPV's GUI 200 to be displayed in its central viewing window 210.

In the FIG. 4 embodiment of the invention disclosed, and herein taught to those skilled in the art, another down arrow click 113 of the IPTV device's 120 remote control 110-E by the end viewer next puts the IPV′ GUI 200 into Image Mode 250. As with Info Mode 240, again enabling Image Mode 250 allows the end viewer to call up and view an unlimited number of remotely served, yet easily navigable, informational image screens 252, 254 & 256, interactively providing end viewers with any number images of graphical, imaged or pictorial information that may (or may not) be relevant to the film, movie, television show or video clips 150 contained within the non-interactive IPTV audio0video content stream 190 packets transmitted.

Said informational image screens 252, 254 & 256, viewed from within Image Mode 250, can contain anything ranging from historical and biographical pictures and/or behind the scenes promotional images, to production images or movie posters, to name just a few items of what may be contained within such image screen elements 252, 254 & 256, so as to enhance the end viewer's knowledge or their informational, educational, entertainment and/or end viewing experiences.

Choices and navigation through the informational image screens 252, 254 & 256 in Image Mode 240 are set forth in FIG. 4, wherein by pressing the IPTV device 120 remote's 110-E down arrow key 113 once, moves the focus or control of the IPV's 200 GUI 210 from Info Mode 240 to Image Mode 250. Informational image screen elements 252, 254 & 256 can also be viewed in a forward or reverse sequence by pressing the IPTV device 120 remote's 110-F right arrow or left arrow keys 115. Pressing the remote's 110-G “OK” or “Select” key 117 displays the informational textual screen 242, 244 & 246 elements in full-screen mode, while again pressing the remote's 110-G “OK” or “Select” key 117 returns the sequenced display of the informational image screen elements to once again be viewed at reduced size, fitting within the IPV GUI's 200 central display window 210. Pressing the remote's 110-H “Play” key 119 displays the informational text screen elements 242, 244 & 246 in an automatic slide show sequence.

Additionally, when needed and desired by the end viewer interacting with the media being displayed by the IPV's GUI 200, pressing the 110-G “OK” or “Enter” 117 button on the remote (or other buttons on different remotes used on other IPTV devices in other embodiments of the invention) can remove the IPV's GUI 200 altogether and display the informational textual 242, 244 & 246 screens, image 252, 254 & 256 screens, and/or advertising screens 254 in full screen minus displaying any portion of the IPV's GUI 200 (ie., the GUI 200 is removed from the viewing media and the end viewer can display the whole informational text or images sequence in full screen or any advertisement images in full screen.) In both instances in this embodiment of the inventive and unique system, pressing the remote's “OK” 110-G or 117 “Select” key will toggle the informational text 242, 244 & 246 and/or the informational image screens 252, 254 & 256 between full screen or cause the same to be be viewed within the IPV's central viewing window 210 at a smaller size. Said screens can be navigated by pressing the IPTV device's 120 remote 110 forward or back keys (FIG. 3, 110-B, 114 or FIG. 4, 110-F, 115) in either full screen display mode or with said screens placed and displayed within the IPV central viewing window 210. Likewise, pressing the play button 118 on the remote in this mode of the invention will automatically play either of said informational screens in a slide show type sequence with a variable pause between each of said informational text 242, 244 & 246 or image 252, 254 & 256 screens. Such slide show functions, when displaying said informational text 242, 244 & 246 or image 252, 254 & 256 screens may do so in either a full screen mode method or in a GUI 210 windowed display mode method. Whereas the said later screens are displayed and fitted into the IPV GUI's 200 central viewing window 210.

### Banner Ads Profit Centers

The clickable Banner Advertising Area 260, located at the lower portion of the IPV's GUI 200 are received from a remote server 160, and stored as archival advertisements on hard disk(s) or in ‘the cloud’ and may be updated or changed at any time, accordingly either by remote access to the server 160 or by working at the site of the server 160, by those personnel managing and maintaining such ad servers 160.

The Banner Advertisement Area 260 located at the lower portion of the IPV's GUI 200 in this method of the inventive system, creates yet another basis for unique profit and revenue centers heretofore not available from viewing non-interactive content or media streams (FIGS. 1, 190 & 100), as streaming such non-interactive content 190 to IPTV receiving devices 120, (including receiving devices with a CPU and equipped with audio-video outputs, such as cellular phones, tablets, and other touch screen devices, and according to the research and development testing completed as of the date of this application filing, do not have any such methods available to yield such revenue models or profit centers as disclosed within the inventive system as is being taught herein to those skilled in the art of the methods, means and systems comprising the unique invention.

Further, any number of (or unlimited) advertising banners 260 may be pushed to the IPV's GUI 200 at any given time within the playback of the non-interactive streaming media, TV show, film or other audio or audio-video streaming content 190 & 150 at the discretion of the IPTV streaming content firm 170 or those individuals managing and maintaining such banner advertising.

Other advertising profit centers may be generated within the methods and systems of the invention disclosed herein, by displaying advertising screens displayed in Info Mode 240 and Image Mode 250 within the IPV GUI's 200 central viewing window 210, which can be intermingled within any sequence of informational text screen elements 242, 244 & 246 and/or image screen elements 252, 254 & 256 when the IPV is in Info Mode 240 focus, or likewise, other advertising profit centers may be built by displaying advertising screens within the IPV GUI's 200 central viewing window 210, which can be intermingled within any sequence of image screen elements 252, 254 & 256 when the IPV's GUI 200 is focused in Image Mode 250.

Further, the banner advertising area 260 may be located anywhere on the IPV's GUI 200 where space for said is permissible. In this method and embodiment of the inventive system, when clicked upon, the banner ad 260 disappears and is replaced by a full screen display ad (not shown), or alternately on other IPTV enabled devices 120 that have web browsers capabilities built into them, as well on those devices with a CPU and audio-videos output, touching or clicking on a banner advertisement 260 will take the end user to the advertiser's web site. Presently, such IPTV devices 120 capable of streaming standard non-interactive audio-video content 190, and which include web browser capabilities, such as those iOS or Android based cellular phone and tablet devices, and more particularly and specifically, TVs 100 equipped with web browser capabilities, such as when using LogiTech's Revue, or Avov's set top IPTV devices, or Internet connected DVD players, or TVs 100 with built in streaming standard IPTV capabilities, such as Android TV devices, based on the well known Android OS (operating system.) Currently, other IPTV enabled devices 120, such as AppleTV, Western Digital TV, Avov boxes and most other JAVA based Internet ready TVs and DVD players, do not have web browser capabilities, but it is anticipated that these and other such devices will have such web browser capabilities in the near-future, which are presently and can be implemented within other embodiments of the methods of the inventive system detailed and taught herein.

### Connections of Main Elements and Sub-Elements of the Inventive System Disclosed

The main elements and methods of the IPV's GUI 200, such as the central viewing window 210 for its Media 230, Info 240 and Image Modes 250, and the unlimited rotating banner advertising elements 260, rely on the onscreen sub-elements of user controls 220 and mode selection buttons or user media display controls 230, 240 & 250 to permit the end user to have control over both navigation of the sub-elements of the IPV's GUI 200 as well as the media sub-elements of the IPV's GUI 200 which together comprise the interactive display of the various medias that may be displayed as desired within the IPV's GUI 200 as made possible within the methods and systems of the invention disclosed.

### Specific Embodiment and Best Mode of the Invention

The information disclosed hereinafter, in combination with the detailed description of the invention provided above, describes a specific embodiment of the invention. This embodiment of the invention is the best mode of the invention as known to the inventor as of the date of the filing of this application. This embodiment of the invention implements the disclosed process as computer software and utilizes Internet streaming content devices connected to TVs and any such device with a CPU, output display and audio capabilities, to display the hidden or concealed multimedia presentation until the Interactive Playback Viewer's (IPV) Graphical User Interface (GUI) of the invention is invoked.

As shown in FIG. 1, a classic western film is being viewed on an HDTV set 100 delivered via a non-interactive and linear IPTV media content stream 190. Such non-interactive IPTV streams of standard audio-video content 190 provide no additional information to the end viewer, just as if the end viewer were watching the show or content stream from a non-interactive DVD or VHS video tape. Further, it is well know that without the unique methods and means within the systems and methods disclosed herein of the instant invention, businesses or firms 170 (such as Hulu, Netflix, Crackle, Blockbuster, Amazon, et al) that are engaged in the streaming of typical, standard or linear non-interactive IPTV content streams of audio and video 190 to IPTV ready devices 120 have no means or methods (other than interrupting the content stream with a standard video advertisement of various lengths as seen and broadcast on any standard TV's 100 analog or digital cable channel) for generating additional revenue streams from the content that they are streaming. Therefore, and as disclosed, the instant invention enables and creates new and unique revenue streams and profit models, within Info Mode 240, Image Mode 250 and its rotating Banner Advertising mode and area 260, by its other unique methods and systems for wrapping such content within an informational and interactive environment.

Further, because content streaming firms 170, and as noted above, have built large software infrastructures around the typical IPTV content that they now stream, another unique objective and method of the inventive system is for it to be transparent to the end viewer 100 so as to not interrupt the content stream 190 being viewed until invoked (requested) by the end viewer. As such, since the inventive system is an add-on companion to standard, typical or linear IPTV content streams 190, streaming content firms 170 do not have to expend any sizable resources so as to have the need to completely reprogram their existing content delivery web sites or user delivery interfaces. For example, audio- and video clips on a website are often surrounded with additional and often large amounts of descriptive text, as well as a multitude of images, of which both are used as adjunctual information relevant to the audio-video clips embedded in the web site's various web pages and as presented to online users. Alternately, when those audio-video clips are now used and presented as streaming media using IPTV devices 120 for viewing on TVs 100, such web site textual and still images relevant to the audio-video content stream can not be viewed by end users viewing the content stream being displayed on their HDTV's 100. Alternately, using the unique methods and means of the instant invention, the same text and images used on the web sites that is relevant to the web site's audio-video clips, can easily be repurposed for use and interactive display to end users watching their HDTVs 100 utilizing the unique methods and means of the inventive system disclosed and taught herein. Such interactive display of these textual 240 and image 250 elements in the methods of the inventive system disclosed, and where which such textual and pictorial information, data and files already exist on the audio-video content owners web site, can be accomplished to the benefit of the end user watching their HDTVs 100 within the invention's IPV using its GUI 200, and also displaying within it central window 210 and incorporating the invention's Media Modes 230, Info Modes 240 and Image Modes 250. More particularly, when used within such unique methods and means of the instant invention, such repurposed web site graphical and textual content can create new profit centers and revenue generation by intermixing advertising within the Info Modes 240 and Image Modes 250 of the instant invention, as well as including revenue which can further realized through the invention's unlimited rotating banner advertising elements 260. Therefore, without the utilizing the unique systems, methods and means of the instant invention, such revenues would be lost to the audio-video content owner when streaming it 190 to HDTV 100 viewers in traditional, non-interactive linear content streaming methods presently used and viewed by end-users on their HDTVs 100.

Such reduction of costs and increases of revenue benefits to such firms that simply stream standard or linear IPTV non-interactive content 190, was and has been a constant in the research, development, realization and creation of the unique and inventive system disclosed. Again, and as previously set forth above in more detail, personnel maintaining a company's web site could also just as easily utilize the web site's textual and image data in the interactive display modes in the art of the instant invention taught within this document.

What has been described and illustrated herein by the inventor is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest and most reasonable descriptions herein, unless otherwise indicated. Any headings utilized within the description are for convenience only and intended to have no limiting effect on the disclosed embodiment or other embodiments of the invention.

### Alternative Embodiments of the Invention

The inventor has set forth the current best known method of the invention as it functions currently, as initially developed and programmed on a Roku IPTV device 120 and as when connected to Standard Definition or High Definition televisions 100. The Roku IPTV device 120 utilizes a programming language known within the industry and programmers as the Brightscript programming language, which is a hybrid of the Javascript programming language. In this embodiment of the invention, the Brightscript programming language has been implemented and programmed to generate the software code required to build and control the Roku IPTV device 120 and display and control all the above elements interactively, as in the case of this embodiment of the inventive system, are when invoked, displayed within the previously concealed or hidden multimedia presentation's IPV's GUI 200. Other IPTV devices 120, which function on the JAVA based Android IPTV 120 devices, or Apple ITV devices 120 which are based on versions of Apple's iOS operating systems and programming languages, however, other embodiments of the methods and systems of the invention disclosed may utilize different but similar methods for their GUI's 200 to further the methods taught within this instant application of the unique and inventive system disclosed. It is highly foreseen, and as as is being currently experienced, that when re-programming and converting the methods and systems detailed within for the Roku IPTV device 120 to other such IPTV capable streaming devices (by reference also 120), and for those devices having a CPU and at least audio-video output capabilities, that other programming languages will require that modifications to both the visual elements and internal elements of the IPV 210 and/or its GUI 200 to be undertaken.

1. A method for providing and invoking a concealed multimedia presentation to users of media streaming devices or other analog or digital audio-visual media receiving devices with a central processing unit equipped with an output visual display and audio device, comprising:
receiving from a server or other transmission devices by radio and other frequencies in known broadcast and telecommunication spectrums, a concealed multimedia presentation, that at the user's discretion, does not interrupt the playback of the audio and video components of a digital or analog media stream or the digital or analog audio/video component data displayed, of which when invoked, the concealed multimedia presentation may or may not include or contains or may contain any encode, encrypted or encoded or non-encoded number of elements or all elements of video component data and files, audio component data and files, text component data and files, hyperlink data and files, XML data or files, HTML data or files or other such textual component data or files, still raster image data or files, vector image data or files, graphic component data or files, motion or still vector image graphic component data or files, and synchronization data or files, of which any one of said component data or files, pr or none of any said component data or files, or any combination of such component data or files, and or the such elements of the concealed multimedia presentation may or may not be encoded, or may or may not be encrypted; and
when invoked, the concealed multimedia presentation displays an interactive multimedia presentation with a graphical user interface comprising at least a primary display area for the displaying and interactive playback of encrypted or non-encrypted or encoded or non-encoded multimedia presentation component video, audio, textual, and/or raster or vector component data or files; and
when required the hidden multimedia presentation defines and displays a secondary display area, which may or may not interactively playback encrypted, non-encrypted or encoded or non-encoded multimedia component video, audio, textual, and raster or vector component data or files, any of which may or may not be decrypted or unencoded for display in the optional secondary display area, and wherein when required the hidden multimedia presentation provides user display controls to interactively display a decrypted, or decoded multimedia presentation, when and if the said multimedia is determined to be encoded or encrypted; and
concurrently displaying when required, in the primary or secondary display areas, decrypted or decoded multimedia presentation component data or files, when determined that said data or files are encrypted or encoded, any of which said component data or may or may not be respectively associated with the primary and secondary display areas, and if the later is required, in accordance with user commands entered through the user display controls and further in accordance with the decrypted or decoded synchronization component data or files, if such synchronization component data or files are encoded or decrypted.

2. The method and methods recited in claim 1,
wherein the concealed graphical user interface of the hidden multimedia presentation when invoked may or may not also further comprise of a third display area, when required or desired; and wherein displaying the interactive playback of such encrypted or encoded or non-encrypted or non-encoded multimedia component video, audio, textual, and raster or vector component data or files, further comprises concurrently displaying when desired or required in the third display area decrypted or decoded multimedia presentation component data or files, when determined to be encrypted or encoded, which may be associated with and displayed within the multimedia presentation's third display area; and
wherein when invoked the components of the concealed multimedia presentation and its displaying and interactive playback of encrypted or non-encrypted or encoded or non-encoded multimedia component video, audio, textual, and raster or vector component data or files, and wherein such multimedia component data and files may be included or contained within a single encrypted or encoded multimedia presentation data file, wherein some or all of the elements comprising the multimedia presentation are stored or contained therein for later decryption or decoding for interactive playback as a multimedia presentation when unhidden when invoked, or wherein such multimedia component data and files may be included or contained within a single un-encrypted or unencoded multimedia presentation data file, or may included or contained within multiple un-encrypted or un-encoded multimedia presentation component data or files, wherein some or all of the elements comprising the multimedia presentation are stored or contained therein for later interactive playback as a multimedia presentation when when invoked to be unconcealed and displayed; and
wherein displaying comprises, when determined to be encrypted or encoded, decrypting or decoding the multimedia presentation from either single or multiple multimedia presentation component data or files, or those data, components files or elements comprising the concealed multimedia presentation; and
when determined to be encrypted or encoded in a single multimedia presentation file, which sequentially are then extracted from a single or multiple decrypted or decoded multimedia presentation data file, of which decrypted or decoded file(s) or data portions, elements or components, wherein a decrypted or decoded file or files, when required, associated with concurrently decrypted or decoded multimedia component video, audio, textual, and raster or vector component data or files, any of which may or may not be encoded and displayed as multimedia presentation components.

3. The method and methods recited in claim 1,
wherein when desired or required, the audio and video components of the encrypted or encoded multimedia presentation data, are stored in either a single or multiple encrypted or encoded file or files, and when decrypted or decoded, are audio/video elements that when required are either interleaved or non-interleaved or in singular and separate data and file formats; and
wherein, when required or desired, the audio and video components of the encrypted or encoded component data or files that comprise the concealed multimedia presentation, when required, are encrypted or encoded and may be stored in either multiple files or s single file, and when required, are decrypted or decoded audio component files and decrypted or decoded video component files in non-interleaved component audio and video data and file formats; and
wherein displaying comprises, when required, decrypting or decoding and sequentially extracting, from a single encrypted or encoded multimedia presentation data file, or multiple encrypted or encoded multimedia presentation data files, decrypted or decoded data portions of a decrypted or decoded file or files associated with decrypted or decoded concurrently displayed components; and

4. The method and methods recited in claim 1,
wherein the method further comprises decrypting or decoding, and when required, extracting from the encrypted multimedia presentation data file or multiple multimedia presentation data files, portions of the decrypted or decoded audio data or a decrypted or decoded audio file or files synchronized with the decrypted or decoded displayed components; and
wherein the method further comprising decrypting or decoding when required, password data and time and or date expiration data and information to either confirm or deny extraction from the encrypted or decoded single multimedia presentation data file or multiple encrypted or decoded single multimedia presentation data files, when and if required or desired to be encoded or encrypted, to confirm or deny the display or non-display of portions of decrypted or decoded data or decrypted component multimedia files, or non-encrypted or non-encoded component multimedia data, or that when required, are contained within non-encrypted or non-encoded multimedia presentation data; and
wherein the encrypted or encoded, or non-encrypted or non-encoded multimedia presentation data file or multiple multimedia presentation files, is or are represented by a single data file identifier or multiple data file identifiers.

5. A system for providing and invoking a concealed multimedia presentation when desired with the option for the means of displaying a graphical user interface comprising at least a primary display and the option of displaying a secondary display area and user display controls to users of media streaming devices or other analog or digital audio-visual media receiving devices with a central processing unit equipped with an output visual display and audio device, comprising:

6. The system recited in claim 5.
receiving from a server or other transmission devices by radio and other frequencies in known broadcast and telecommunication spectrums, and when invoked, a concealed multimedia presentation, with the option for the means of displaying a graphical user interface, of which the concealed multimedia presentation's optional graphical user interface may or may not include or contains or may contain any number of or all elements of video component data or files, audio component data or files, text component data or files, hyperlink component data or files, XML component data or files, HTML component data or files, or other such textual component data and files, still raster image component data or files, vector image component data or files, or graphic component data or files, motion or still vector image graphic component data or files, and synchronization data or files of which any one of or none or any contamination of such files, component data, and elements of the concealed multimedia presentation and its optional graphical user interface, which may or may not display the above component data files or elements that may or not be encoded or encrypted in either a single file or multiple files; or
wherein any one file or all said files may or may not be determined to encrypted, encoded or non-encrypted or non-encoded; and
the means providing for the concealed multimedia presentation which when invoked displays an interactive multimedia presentation with an optional graphical user interface comprising displaying at least a primary display area, and when required or desired, the option for a secondary display area of concurrently displaying multimedia component data or files, with the option of interactive playback of encrypted or non-encrypted multimedia component video, audio, textual, and raster or vector component data or files, any of which may or may not be encoded; and
when required or desired, the option of the secondary display area interactively or non-interactively providing playback of encrypted or non-encrypted multimedia component video, audio, textual, and raster or vector component data or files, any of which may or may not be encoded in the optional secondary display area, and user display controls to interactively control the decrypted, or decoded or non-encrypted or non-encoded multimedia presentation; and

6. The system recited in claim 5,
wherein when invoked the concealed multimedia presentation's optional graphical user interface further comprises an optional third display area; and
wherein the means for the optional third display area within, and when invoked, the concealed multimedia presentation's optional graphical user interface comprising displaying at least a primary display area, and when required or desired, the option for a third display area of concurrently displaying, with the option of interactive playback, encrypted or non-encrypted multimedia component video, audio, textual, and raster or vector component data or files, any of which may or may not be encoded, and;
when required or desired, the option of the third display area interactively or non-interactively providing playback of encrypted or non-encrypted multimedia component video, audio, textual, and raster or vector component data or files, any of which may or may not be encoded in the optional third display area, and user display controls to interactively control the decrypted, or decoded multimedia presentation in the primary, secondary or third displayed areas or windows, when required or desired; and

7. The system recited in claim 5,
wherein displaying further comprises concurrently displaying in the third optional display area decrypted or decoded or non-encrypted or non-decoded multimedia presentation components, data or files associated with the third display area; and
wherein, when invoked, the components of the concealed multimedia presentation's data, and its optional graphical user interface, files contained within the concealed multimedia presentation's singular data or file or multiple data or files are stored in an either an encrypted, non-encrypted, or an encoded or non-encoded format; and wherein when invoked displaying, when encrypted or encoded, comprises decrypting or decoding the concealed multimedia presentation, and if desired or required, from its optional graphical user interface, displaying an encrypted or encoded singular data file or multiple data files, or a non-encrypted or non-encoded singular data file or multiple data files; or
wherein when invoked, the concealed multimedia presentation, within or not within its optional graphical user interface, displaying the non-encrypted, or non-encoded concealed multimedia presentation from multiple non-encrypted or non-encoded data files; or
when encrypted or encoded, extracting from the decrypted or decoded concealed multimedia presentation's data file or multiple decrypted or decoded multimedia present at data files, decrypted or decoded data portions and or a decrypted or decrypted file or files associated with decrypted or decoded and concurrently displayed multimedia presentation components of the concealed multimedia presentation or its optional graphical user interface; and

7. The system recited in claim 5,
wherein the audio and video components, of the concealed multimedia presentation, or its optional graphical user interface are stored in an encrypted or encoded singular data file or in multiple encrypted or encoded data files are stored in any audio/video interleaved data formats or any non-interleaved audio/video component file formats; or
wherein the audio and video components, of the concealed multimedia presentation, and/or or its optional graphical user interface, are stored in non-encrypted or non-encoded singular or multiple data files are stored in any audio/video interleaved data formats or any non-interleaved audio/video component file formats; and
wherein displaying comprises decrypting or decoding and extracting, from an encrypted or encoded multimedia presentation data file, or multiple encrypted or encoded multimedia presentation files, decrypted or decoded data portions, or a decrypted or decoded file or files associated with decrypted or decoded concurrently displayed components, when invoked, of the concealed multimedia presentation, or its optional graphical user interface; or

8. The system recited in claim 5,
wherein displaying comprises extracting from a non-encrypted or non-encoded multimedia presentation data file, or multiple non-encrypted or non-encoded multimedia presentation files, non-encrypted or non-decoded data portions or a non-decrypted or non-decoded file or files associated with concurrently displayed non-decrypted or non-encoded components, within, when invoked, the concealed multimedia presentation, or its optional graphical user interface; and
the system further comprising decrypting or decoding and extracting from a single encrypted multimedia presentation data file, or from such encrypted or encoded multiple files, portions of decrypted or decoded audio data or a decrypted or decoded audio file or files synchronized with the decrypted or decoded displayed components; or

9. The system further comprising:
decrypting or decoding and extracting from a single encrypted or encoded multimedia presentation data file, or from such encrypted or encoded multiple files, portions of decrypted or decoded audio data or a decrypted or decoded audio file or files synchronized with the decrypted or decoded displayed components; or further comprising extracting from a single non-encrypted or non-encoded multimedia presentation data file, or from multiple non-encrypted or non-encoded component files, portions of audio data or an audio file or files synchronized with the non-encrypted or non-decoded displayed components; and

10. The system recited in claim 9,
further comprising decrypting or decoding password data and time and or date expiration data and information to either confirm or refute extraction from a single encrypted multimedia presentation data file, or from multiple encrypted multimedia presentation data files to confirm or refute the display or non-display of portions of decrypted or decoded data or decrypted or decoded component multimedia files contained within; or
when desired or required further comprising password data and time and or date expiration data and information to either confirm or refute extraction from a single non-encrypted or non-encoded multimedia presentation data file, or extracted from multiple non-encrypted or non-decoded multimedia presentation data files to confirm or refute the display or non-display of portions of decrypted data or decrypted component multimedia files contained within; and

11. The system recited in claim 9,
wherein encrypted or encoded files or a single encrypted or encoded multimedia presentation data file containing the components of the concealed multimedia presentation, and/or its optional graphical user interface, can be or may not be represented by a single data file identifier; or wherein non-encrypted or non-encoded files or a single non-encrypted or non-encoded multimedia presentation data file, either of which may contain or be containing the components of the concealed multimedia presentation, and/or its optional graphical user interface, optionally can be or may not be represented by a single data file identifier.

12. A computer readable storage medium having stored therein machine readable data representing control programming for controlling performance of a system for providing a concealed interactive multimedia presentation, with or without optional graphical user interface, the system providing the functions of:
receiving from a server or other digital or analog transmission devices or by radio frequency and other frequencies in known broadcast and telecommunication spectrums:
an encrypted or non-encrypted data file or files of a concealed multimedia presentation, with or without an optional graphical user interface, concealed multimedia presentation data or singular or multiple files thereof, any of which may include or may contain elements of or complete encrypted or non-encrypted video component data or files which includes or may contain elements of or complete encrypted or non-encrypted audio component data or files, of which none, one or more or any combination thereof which includes or may contain elements of complete encrypted or non-encrypted text component data or files, none, one or more of any combination of encrypted or non-encrypted hyperlinks, XML, HTML or other textual component data and files, none, one or more of any combination of elements of or complete hyperlinks, XML, HTML or other textual component data or files, none, one or more or any combination of encrypted or non-encrypted still raster image or graphic component data and files, none, one or more or any combination of encrypted or non-encrypted motion or still vector image or graphic component data and files, and encrypted or non-encrypted synchronization data or singular or multiple synchronization files; and
displaying when invoked a concealed multimedia presentation, with or without an optional graphical user interface, comprising at least a primary, and if required or desired optional secondary or third interactive or non-interactive multimedia display areas, and user display controls; and
concurrently displaying, when required or desired, optional secondary and third interactive or non-interactive display areas, wherein decrypted multimedia presentation component data or files that can or may not be or respectively associated with the primary display area, in accordance with user commands entered through user display controls and further in accordance with the decrypted or non-encrypted synchronization file, files or data; and

13. The computer readable storage medium recited in claim 12,
wherein the concealed multimedia presentation, with or without graphical user interface, further comprises within the required or desired secondary or third interactive or non-interactive multimedia display areas; and
wherein displaying further comprises, when invoked, the concealed multimedia presentation's graphical user interface, concurrently decrypted or non-decrypted multimedia presentation components within the primary display within or without the graphical user interface, or optionally displaying in the secondary or third display areas, interactive or non-interactive multimedia presentation components that may or may not be associated with the primary, secondary or third display areas; and

14. The computer readable storage medium recited in claim 12,
wherein the component data and files of the concealed multimedia presentation data file, may be stored in encrypted or non-encrypted formats that may contain encrypted or non-encrypted password or date expiration data and information; and
wherein displaying comprises, when invoked the concealed multimedia presentation with or without graphical user interface, extracting from an encrypted or non-encrypted multimedia presentation data file or data files, decrypted or non-encrypted data portions and or decrypted or non-encrypted component data or files associated with concurrently displayed and decrypted or non-encrypted interactive or non-interactive multimedia components; and

15. The computer readable storage medium recited in claim 12,
wherein the component data, file or files of the concealed multimedia presentation data file or multiple data files may or may not be stored in an encrypted format and which may contain encrypted or non-encrypted password or date expiration data and information; and
wherein displaying, when invoking the concealed multimedia presentation, with or without a graphical user interface, comprises extracting from an encrypted or non-encrypted multimedia presentation data file or files, decrypted or non-encrypted data portions and or decrypted or non-encrypted component data files associated, with or without invoking the concealed multimedia presentation's graphical user interface, with concurrently displayed decrypted or non=encrypted interactive or non-interactive components; and
the method further comprising extracting, from the encrypted multimedia presentation data file, portions of decrypted or non-encrypted audio data or a decrypted or non-encrypted audio file or files synchronized with the decrypted or non-encrypted displayed components; and

16. The computer readable storage medium recited in claim 12,
wherein, with or without displaying the concealed multimedia presentation's graphical user interface, the encrypted or non-encrypted concealed multimedia presentation data file, is represented by a single data file identifier or by multiple data file identifiers.
